(19) United States
(12) Patent Application Publication
(10) Pub. No.: US 2005/0097086 A1
(43) Pub. Date: May 5, 2005

(54) System and method for migrating an application developed around an ISAM database server to an SQL database server without source level changes

(76) Inventor: Riaz Merchant, Miami, FL (US)

Correspondence Address: CHARLES E. BAXLEY, ESQ., 90 JOHN STREET, THIRD FLOOR, NEW YORK, NY, 10038, US

(21) Appl. No.: 10/699,074

(22) Filed: Oct. 30, 2003

(51) Int. Cl. G06F 7/00

(52) U.S. Cl. 707/3

(57) ABSTRACT

A system and method for migrating an application developed around an ISAM database server to an SQL database server without source level changes. A database driver translates calls made to the ISAM database server from the application into SQL statements that work with the SQL database server. Whether the SQL database server is an MS SQL server or any other database server, e.g. an Oracle server, a database migration tool replaces existing dynamic link libraries of the ISAM database server, and the database driver effectively intercepts and relays application commands to the SQL database server as optimized, efficient SQL statements.

### BACKGROUND OF THE INVENTION

1. Field of the Invention

The present invention relates to a system and method for migrating an application developed around an ISAM database server. More particularly, the present invention relates to a system and method for migrating an application developed around an ISAM database server to an SQL database server without source level changes.

2. Description of the Prior Art

The Internet revolution has underscored the importance of making data available reliably and at a high speed to an ever-growing user base. Corporations continue to consolidate their data into a single, corporate-wide database so that information about its customers, products, and market can be easily extracted and manipulated, and at the same time allow customers and mobile work forces to update and retrieve information anytime, anywhere. These new, data-intensive demands of today's businesses require a database server that is robust, scalable, gives excellent response time in extracting and manipulating data, has great disaster recovery features, guarantees 24×7 availability, and above all provides excellent security features.

Relational or SQL (Structured Query Language) database servers from companies like Oracle, Microsoft, IBM, and others meet these criteria. Indeed the features of these database servers, combined with the marketing might of these “software heavyweights” have helped make relational database servers a de facto standard in the business application market.

Companies using or developing applications written around the transactional database servers, which utilize the Index Sequential Access Method (ISAM) or transactional approach to data storage and retrieval, find that moving their applications to the industry leading SQL database servers presents significant challenges. There are two obvious migration paths, to wit: rewriting entire applications written around the transactional paradigm to support relational approach using SQL or set paradigm; and writing a new application from scratch. Both require significant resources and time and may not be feasible for many companies.

The case for relational database servers can be made on two fronts. First, the relational model for data storage and retrieval has proven to be superior at handling large amounts of data and turning that data into useful information without requiring special programming techniques. The reason for this superiority is the Structured Query Language (SQL). This relatively simple language allows complex data manipulation using only a few simple commands. Second, because of this superiority and simplicity, as well as the standardization of the SQL, almost all major software providers support SQL database servers through Open Database Connectivity (ODBC), OLEDB, or native programming interfaces. Companies switching to an SQL database server not only get a robust, more efficient enterprise-wide data solution, but they also get access to a variety of tools and applications that work seamlessly with SQL database servers.

To meet the stringent demands placed on database servers due to data consolidation, corporate users of database applications want the power, scalability, and reliability offered by industry leading relational database servers. Corporations who have their data scattered over disparate database servers often face difficulties in using business analysis, reporting, and other business tools that are crucial from a corporate perspective.

In many cases companies may already be using an SQL database server with newer applications, yet still have some applications using ISAM database servers. This lack of standardization often presents integration issues for the IT department. Applications can be modified or rewritten to support a single corporate database server standard. This, however, can be an expensive and time-consuming option.

In an effort to consolidate data quickly companies may be willing to pull the plug on their existing applications and opt for an off-the-shelf solution that integrates well with mainstream database servers. But adopting a new application is more than just buying a piece of software and installing it. IT departments have to contend with implementing the new product, testing it, rolling it out to select users, further testing, Q&A, and finally deploying it. And, then there is the cost associated with retraining end-users on the new software.

Developers face two hurdles in the SQL database server standardizing market. First, their already established customers often want the ability to run their applications on a mainstream database server. Second, to expand their customer base these developers need to find new customers. Since 90% of the customers buying database servers chose an SQL database server solution, it is imperative that application developers who are looking to attract new customers support SQL database servers.

These hurdles have left the developers using ISAM database servers, such as, but not limited to, BTRIEVE® and DATAFLEX® with only one option—roll up their shirt sleeves and learn to program with SQL and potentially re-code thousands of lines of code to accommodate the set-based paradigm of SQL. Not an easy task!

Thus, there exists a need for a system and method for migrating an application developed around an ISAM database server to an SQL database server without source level changes.

### BRIEF SUMMARY OF THE INVENTION

ACCORDINGLY, AN OBJECT of the present invention is to provide a system and method for migrating an application developed around an ISAM database server to an SQL database server without source level changes that avoid the disadvantages of the prior art.

ANOTHER OBJECT of the present invention is to provide a system and method for migrating an application developed around an ISAM database server to an SQL database server without source level changes that are both flexible and cost efficient to handle the migration issue.

STILL ANOTHER OBJECT of the present invention is to provide a system and method for migrating an application developed around an ISAM database server to an SQL database server without source level changes that allow developers to deploy their applications with ISAM database servers as well as with an SQL database server without requiring recompilation or code rewrite.

YET ANOTHER OBJECT of the present invention is to provide a system and method for migrating an application developed around an ISAM database server to an SQL database server without source level changes that allow an application currently working exclusively with ISAM database servers to be able to work with an SQL database server in very little time, following a few easy steps.

STILL YET ANOTHER OBJECT of the present invention is to provide a system and method for migrating an application developed around an ISAM database server to an SQL database server without source level changes that are simple to use.

YET STILL ANOTHER OBJECT of the present invention is to provide a system and method for migrating an application developed around an ISAM database server to an SQL database server without source level changes that cut down implementation time allowing the running of existing applications against SQL database servers immediately.

STILL YET ANOTHER OBJECT of the present invention is to provide a system and method for migrating an application developed around an ISAM database server to an SQL database server without source level changes that allow a developer to continue to program in a familiar environment because no changes are required to the source code, i.e. the developer can continue to program in ISAM using its existing development tools and then deploy on multiple database servers.

YET STILL ANOTHER OBJECT of the present invention is to provide a system and method for migrating an application developed around an ISAM database server to an SQL database server without source level changes that open doors to new markets, i.e. the developer is able to continue to support ISAM applications and still have flexibility to offer solutions both for ISAM and SQL database servers.

STILL YET ANOTHER OBJECT of the present invention is to provide a system and method for migrating an application developed around an ISAM database server to an SQL database server without source level changes that are fast and reliable, i.e. all translated functions are optimized to work as effectively as possible with an SQL database server.

YET STILL ANOTHER OBJECT of the present invention is to provide a system and method for migrating an application developed around an ISAM database server to an SQL database server without source level changes that afford easy migration, i.e. since ISAM applications can work concurrently with an SQL database server and ISAM database servers, customers and employees are assured that they won't be severed from the data while the migration moves forward.

STILL YET ANOTHER OBJECT of the present invention is to provide a system and method for migrating an application developed around an ISAM database server to an SQL database server without source level changes that afford corporate wide consolidation, i.e. with the scalability provided by the SQL database servers, data from ISAM database servers can be moved to a single corporate wide database server.

YET STILL ANOTHER OBJECT of the present invention is to provide a system and method for migrating an application developed around an ISAM database server to an SQL database server without source level changes that provide faster reporting by using Crystal Reports or other reporting tools directly with the SQL database server.

STILL YET ANOTHER OBJECT of the present invention is to provide a system and method for migrating an application developed around an ISAM database server to an SQL database server without source level changes that allow integration with other applications and accessing data from other applications.

YET STILL ANOTHER OBJECT of the present invention is to provide a system and method for migrating an application developed around an ISAM database server to an SQL database server without source level changes that have zero retraining cost, i.e. users can continue to use familiar applications.

STILL YET ANOTHER OBJECT of the present invention is to provide a system and method for migrating an application developed around an ISAM database server to an SQL database server without source level changes that are middle-ware software that allow applications written for Index Sequential Access Method (ISAM) database servers, also called transactional databases or oriented databases, to work with rational or set-oriented databases, also called SQL database servers, without requiring source level changes.

YET STILL ANOTHER OBJECT of the present invention is to provide a system and method for migrating an application developed around an ISAM database server to an SQL database server without source level changes whose software acts as a translator, converting function calls made by an application to the ISAM database server to SQL statements which can be understood by a rational or a set oriented database server.

STILL YET ANOTHER OBJECT of the present invention is to provide a system and method for migrating an application developed around an ISAM database server to an SQL database server without source level changes whose translation is done in such a manner that transparency of data operation is maintained from the perspective of the application.

STILL YET ANOTHER OBJECT of the present invention is to provide a system and method for migrating an application developed around an ISAM database server to an SQL database server without source level changes that perform all necessary functional translation to maintain transparency so as to allow an application written for an ISAM database server to work with a set-orient rational database server without require source level modification.

BRIEFLY STATED, YET STILL ANOTHER OBJECT of the present invention is to provide a system and method for migrating an application developed around an ISAM database server to an SQL database server without source level changes. A database driver translates calls made to the ISAM database server from the application into SQL statements that work with the SQL database server. Whether the SQL database server is an MS SQL server or any other database server, e.g. an Oracle server, a database migration tool replaces existing dynamic link libraries of the ISAM database server, and the database driver effectively intercepts and relays application commands to the SQL database server as optimized, efficient SQL statements.

The novel features which are considered characteristic of the present invention are set forth in the appended Claims. The invention itself, both as to its construction and its method of operation, together with additional objects and advantages thereof, will be best understood from the following description of a specific embodiment when read and understood in connection with the accompanying drawings.

### BRIEF DESCRIPTION OF THE DRAWINGS

The figures of the drawings are briefly described as follows:

FIG. 1 is a diagrammatic view of the migration process of the present invention;

FIG. 2A-2B are a process flow chart of the migration process of the present invention;

FIG. 3 is a process flow chart of the setting up process of the present invention;

FIG. 4 is a process flow chart of the identifying and choosing processes of the present invention;

FIG. 5 is a file list dialog box;

FIG. 6 is a process flow chart of the initiating process of the present invention;

FIG. 7A-7B are a process flow chart of the performing process of the present invention;

FIG. 8 is an options dialog box;

FIG. 9 is a diagram of the interaction of the four layers of the migration application when the SQL database server is an MS SQL server; and

FIG. 10 is a diagram of the interaction of the four layers of the migration application when the SQL database server is an Oracle server.

### DETAILED DESCRIPTION OF THE INVENTION

Recognizing the enterprise demand for SQL database servers, such as, but not limited to, those of MS and Oracle, and the hurdles that developers supporting ISAM database servers must overcome to work with industry leading database servers, the present invention, a middle-ware application, is designed to alleviate the costs associated with migrating applications working against existing ISAM database servers to SQL database servers.

The present invention provides developers with a cost-effective, efficient, and platform independent solution to use their existing code with SQL database servers, creates the opportunity for the developer to leverage existing applications with an SQL database server immediately, and accomplishes all of the above without compromising the stability or speed of the application.

The present invention accomplishes these objectives with a family of high performance database drivers designed to translate calls made to an ISAM database server, such as, but not limited to, BTRIEVE® and DATAFLEX® into SQL statements that work with an SQL database server. Whether the SQL database server is an MS SQL server or any other database servers, e.g., but not limited to, an Oracle server, the database drivers of the present invention replace existing dynamic link libraries of the ISAM database server and effectively intercept and relay application commands to the SQL database server as optimized, efficient SQL statements.

With this solution, the database drivers of the present invention successfully provide both corporate users and developers with the most cost-effective and efficient method to work with a SQL database server, such as, but not limited to, an MS SQL server or other SQL databases, e.g., but not limited to, an Oracle server. Apart from significant cost and time savings, developers can use the efficient solution of the database drivers of the present invention to make their applications “database server independent.” They can deploy the same application using ISAM database servers or an SQL database server. No source code changes are needed!

To handle setting up the SQL database server and migrating existing file structures and data of the ISAM database server to the SQL database server, the database drivers of the present invention include a database migration tool to simplify the data migration and the table and index creation process. The database migration tool is an integral part of the database drivers of the present invention and migrates data from the ISAM database server to the SQL database server in such a manner that transparency of data operation is maintained from the perspective of the application. The database migration tool is a standard 32-bit application that runs on the MICROSOFT® WINDOWS™ platform.

The database migration tool translates the database and security information from the ISAM database server to the SQL database server. The database information comprises data files or table definitions and index information.

The database migration tool reads table and index definitions, performs data type translation—mapping data types from the ISAM database servers to the SQL database server, reads security information on files to be translated, generates migration reports and function call traces, allows users to browse data before and after translation, allows switching between the ISAM and the SQL database servers by just adding or removing driver name prefixes, generates scripts for fast loading of data into native types by generating text files and scripts that can be used by the SQL database server for high-speed database migration, allows migrated tables to be removed or dropped from the SQL database server, allows data to be read back into a table of the ISAM database server from a corresponding migrated table of the SQL database server, and generates auxiliary files with appropriate table information so that the database driver—the other component of the invention—can function properly in its task as the functional translator.

The database migration tool is a GUI application that sets up the necessary “environment” and files that are later used by the database driver.

The database migration tool identifies any repository containing information regarding an ISAM database structure to migrate, allows a user to choose which data files of the ISAM database server will be migrated, and initiates migration.

The repository containing information regarding an ISAM database structure includes data dictionaries, file definitions, or file lists, and the ISAM database structure includes tables, indexes, sequences definitions, and any other information defining an ISAM database structure.

The database migration tool allows a user to locate and select a repository containing information regarding an ISAM database structure and display file entries in a file list dialog box by virtue of the database migration tool working with the repository containing information regarding an ISAM database structure.

The database migration tool performs a convert database operation by creating a corresponding table in the SQL database server so as to form a newly created table and copying data of the ISAM database server to the newly created table. During the convert database operation, the database migration tool brings up another dialog box to allow the user to set migration options so as to form selections that are stored in auxiliary files called .INT (intermediate) file and .TD (table definition) file.

The database migration tool copies data at high speeds using native tools for fast data loading, such as native high speed data loading mechanisms and application programming interfaces.

The database migration tool generates SQL scripts to create tables and indexes and adds a driver prefix, which is the name of the driver dll, to a file to identify that the file has already been migrated to the SQL database server.

The database drivers of the present invention further includes a database driver. The database driver is middle-ware software which is either a DLL in the Windows environment or a shared-object or library in the Unix environments. The database driver intercepts functional calls specifying any database operation made to the ISAM database server from the application and translates them into corresponding SQL functional calls and statements. This translation is done in a fashion that allows complete transparency between the relational or set database and the application—the application continues to perform as it normally does and continues to receive and send data to the SQL database server in a format it expects with the ISAM database server.

The database driver uses a native low level API for communicating and accessing the SQL database server. This is a direct connection to the SQL database server.

As an example, when the SQL database server is an MS SQL server, the database driver uses an OLEDB programming interface for communicating and accessing the MS SQL database server, and supports MS SQL server versions 6.5, 7.x, and 2000. This is a direct connection to the SQL database server and doesn't require any ODBC drivers or DSN entries.

As another example, when the SQL database server is an Oracle server, the database driver uses Oracle's Call Interface (OCI) for communicating and accessing the Oracle server, communicates directly with the Oracle server through Oracle's network interface SQL*Net, and supports Oracle versions 8.0x and higher.

The database drivers of the present invention are dynamic link libraries that replace or work side-by-side with the ISAM dlls. The developer does not always have to replace the drivers, rather the developer can make explicit calls in the source code to the data driver of the present invention rather than the ISAM dll which provides the developer the opportunity to work with both data sources, i.e. if migration will take some time, the application can work on the ISAM database server for production and the SQL database server for testing.

As an example, when the ISAM database server is BTRIEVE®, the present invention provides SQL server “enabled” w3btrv7.dll and wbtrv32.dll which can replace the ISAM dlls of the same name.

The type of functional translation the database driver performs is dependent on the ISAM database server and the SQL database server between which it acts as a middle-ware or bridge.

The database driver has the ability to find and fetch a first record of a table based on a given index or a default index, a last record of a table based on a given index or a default index, a next record in a table based on a given index, a previous record in a table based on a given index, a record with index values greater than a current active record based on a given index, a record which has index values greater than or equal to a current active record in a record buffer, a record which has index values less than or equal to a current active record in a record buffer, and a record from a table which has index values exactly the same as a current active record in a record buffer,

The database driver further has the ability to find an existing record, apply changes to the record made by the user via the application interface so as to form an updated record, and save the updated record back in a table of the SQL database server.

The database driver still further has the ability to find a record and delete the record specified by the application, to save a newly created record into a table of the SQL database server, to start a transaction on the SQL database server and provide a same transactional functionality of the ISAM database server, to send a transaction instruction to the SQL database server and make the transaction permanent by committing to disk, and to issue an abort transaction command in the event of an error during a begin/end transaction block so as to allow the transaction to be rolled back restoring record buffers and tables to their original states.

The database driver supports setting and fetching table and database attributes when requested by the application. Such table attributes include finding out a total number of records in the table, a maximum number of records allowed, file mode/read only or not, and changing field names or field types. The database driver when requested by the application fetches a count of the total number of records in the SQL database server and provides it to the applications.

The database driver allows structure of an existing index to be modified by the application, allows functionality to add a new field to an existing table that is supported by the SQL database server, supports creation of a new index on a table, supports deletion of a field from an existing table, and allows dropping an existing index from a table.

The database driver provides a mechanism to implement auto-increment fields that are available in many ISAM databases as well as SQL databases in such a way that the application sees no difference between the ISAM database server and the SQL database server even though the SQL database server handling is different.

The database driver provides support for case insensitive indexes available in most ISAM databases but likely absent in some SQL databases, and for an index that contains ascending and descending index segments in order to avoid costly ORDER BY clauses in an SQL statement.

The database driver provides a mechanism to switch between record-at-a-time access provided by the ISAM database server and set-based access provided by the SQL database server so as to perform order entry or order update by using the record-at-a-time access and for reports or batch processes using set-based access.

The database driver provides a mechanism to support additional commands specific to the database driver that result in increased performance, such as commands that restrict the number of columns to be fetched from a table by allowing the application to switch between complete record and selected fields fetch mechanism by virtue of ISAM databases typically fetching a complete record at a time while most applications written for SQL databases fetch only needed columns or fields from tables.

The database driver provides support for all authentication methods for the SQL database server since the ISAM database server may or may not provide a secure authentication based security service for accessing tables while this is a standard requirement in the SQL database server, automatically pops a login dialog box if a file is opened without being logged onto the SQL database server, and provides support for a login command that can be added to an application either compiled in or externally to support security services. The login command creates a connection handle which uniquely identifies a user connection and which is kept in memory in a data structure during execution of the application. A logout command destroys the memory in the data structure and releases the connection handle.

A file open command is used to open an auxiliary file that is needed to create a memory structure about both ISAM and SQL tables since the ISAM database server has to open a file before it can access a file whereas in the SQL database server there is no concept of file open. The auxiliary file contains information about table structure that is not supported by the SQL database server but is needed by the application, and which is stored both as a binary and as a text file.

The database driver supports a close function by destroying all memory structure created by the file open command and closes a table handle for a table since closing a file of the ISAM database server means the handle for the file is released and the file is no longer used by the application whereas the SQL database server doesn't require a table to be closed.

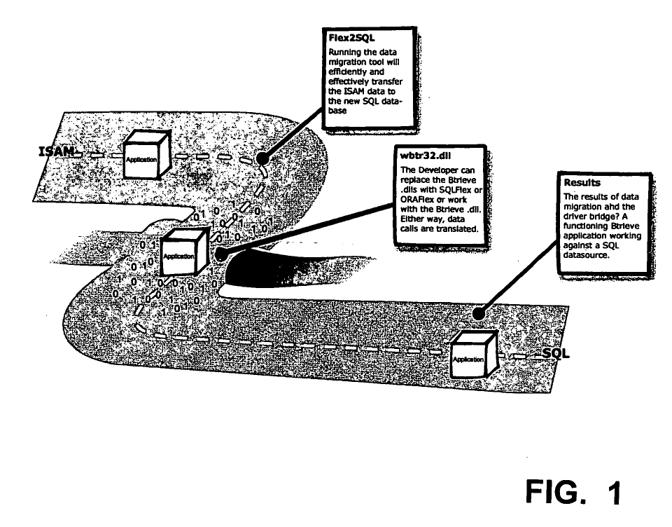

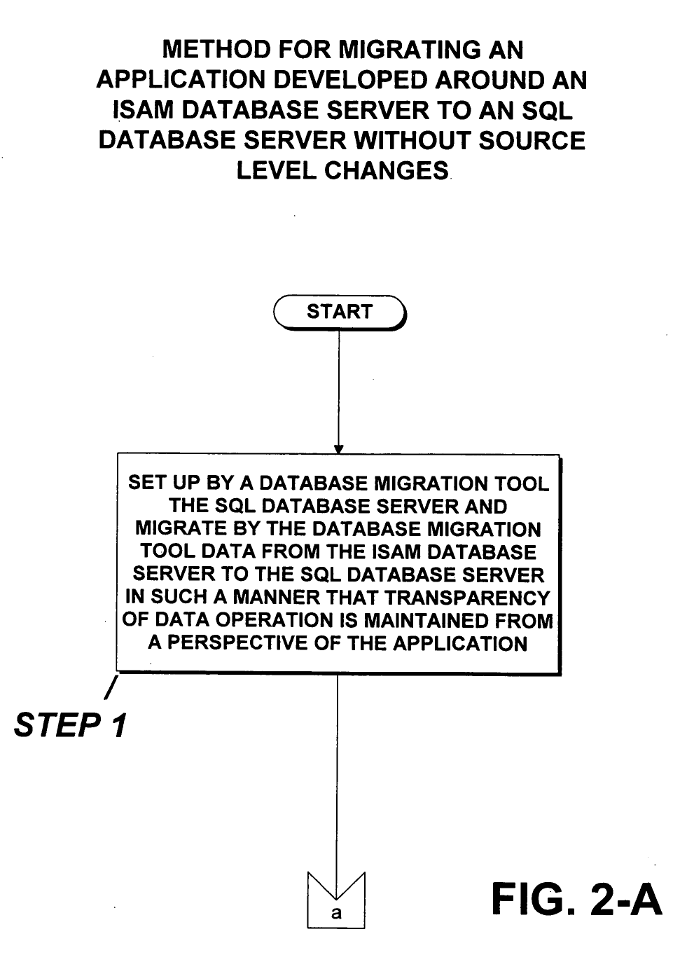

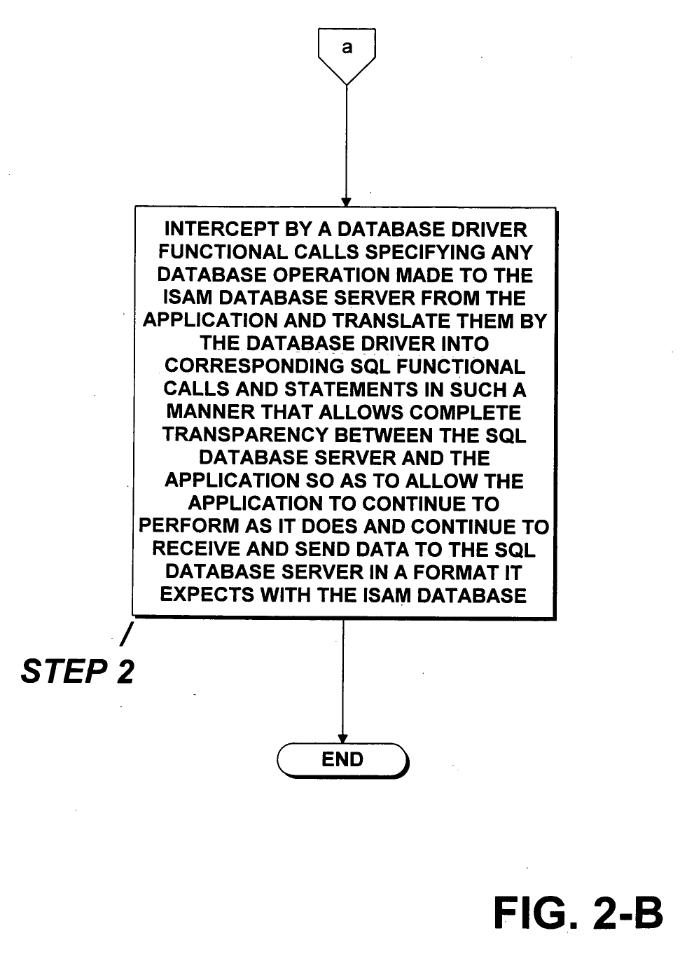

The method for migrating an application developed around an ISAM database server to an SQL database server without source level changes can best be seen in FIGS. 1, 2A, and 2B, which are, respectively, a diagrammatic view of the migration process of the present invention, and a process flow chart of the migration process of the present invention, and as such, will be discussed with reference thereto.

The method for migrating an application developed around an ISAM database server to an SQL database server without source level changes comprises the steps of:
STEP 1: Setting up by the database migration tool the SQL database server and migrating data by the database migration tool from the ISAM database server to the SQL database server in such a manner that transparency of the data operation is maintained from the perspective of the application.
STEP 2: Intercepting by the database driver functional calls specifying any database operation made to the ISAM database server from the application and translating them by the database driver into corresponding SQL functional calls and statements in such a manner that allows complete transparency between the SQL database server and the application so as to allow the application to continue to perform as it normally does and continue to receive and send data to the SQL database server in a format it expects with the ISAM database server.

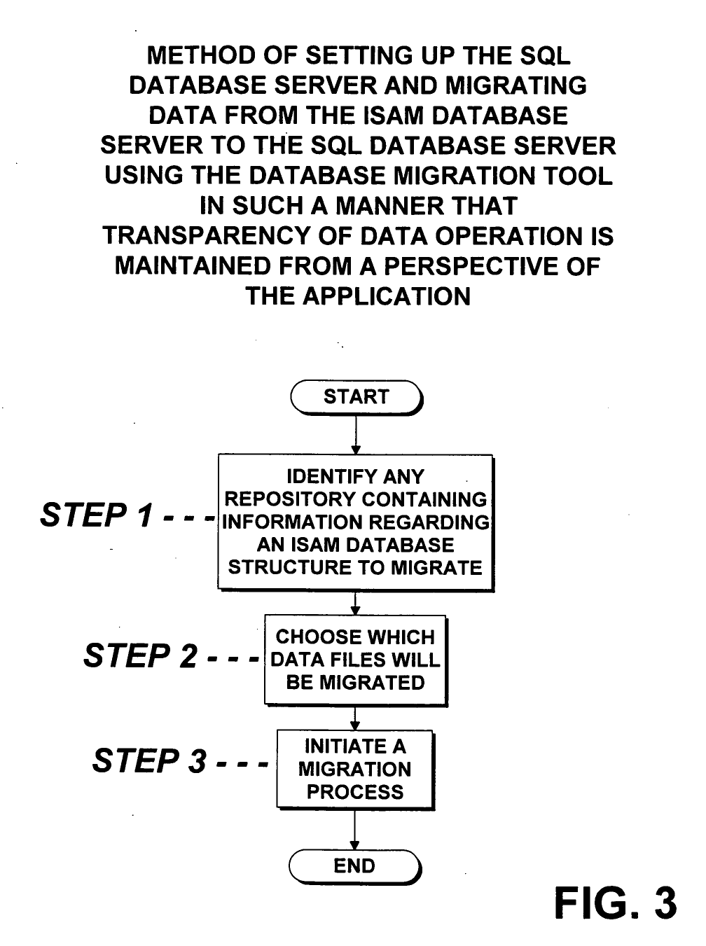

The method of setting up the SQL database server and migrating data from the ISAM database server to the SQL database server using the database migration tool in such a manner that transparency of the data operation is maintained from the perspective of the application can best be seen in FIG. 3, which is process flow chart of the setting up process of the present invention, and as such, will be discussed with reference thereto.

The method of setting up the SQL database server and migrating data from the ISAM database server to the SQL database server using the database migration tool in such a manner that transparency of the data operation is maintained from the perspective of the application comprises the steps of:
STEP 1: Identifying any repository containing information regarding an ISAM database structure to migrate. The repository containing information regarding an ISAM database structure includes data dictionaries, file definitions, or file lists. The ISAM database structure includes tables, indexes, sequences definitions, and any other information defining an ISAM database structure.
STEP 2: Choosing which data files will be migrated.
STEP 3: Initiating a migration process.

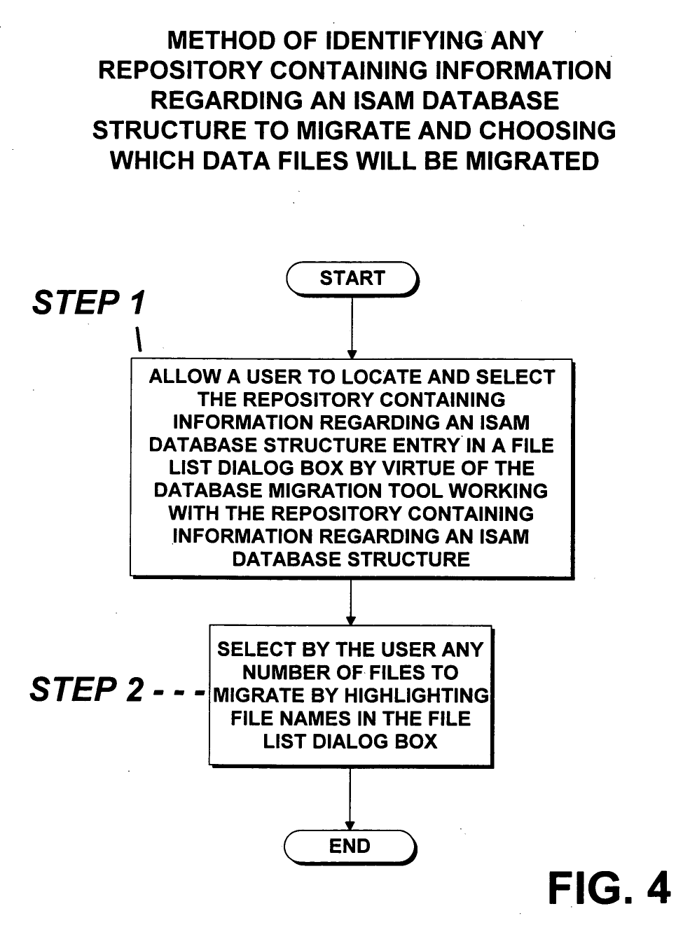

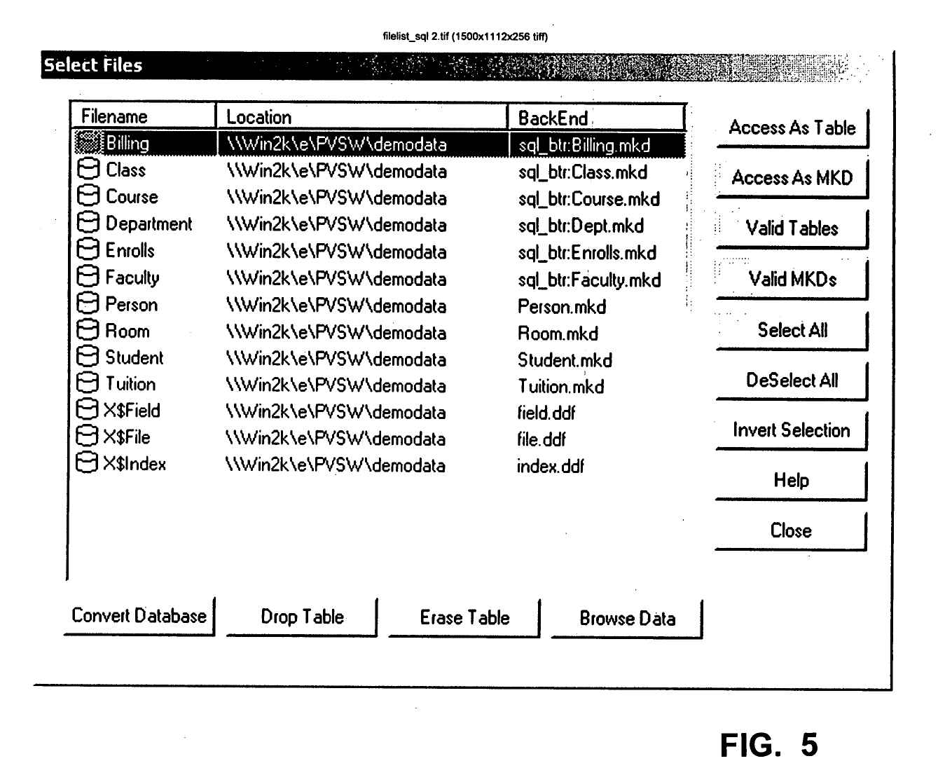

The method of identifying any repository containing information regarding an ISAM database structure to migrate and choosing which data files will be migrated can best be seen in FIGS. 4 and 5, which are, respectively, a process flow chart of the identifying and choosing processes of the present invention, and a file list dialog box, and as such, will be discussed with reference thereto.

The method of identifying any repository containing information regarding an ISAM database structure to migrate and choosing which data files will be migrated comprises the steps of:
STEP 1: Allowing a user to locate and select a repository containing information regarding an ISAM database structure entry in a file list dialog box (FIG. 5) by virtue of the database migration tool working with the repository containing information regarding an ISAM database structure.
STEP 2: Selecting by the user any number of files to migrate by highlighting file names in the file list dialog box (FIG. 5).

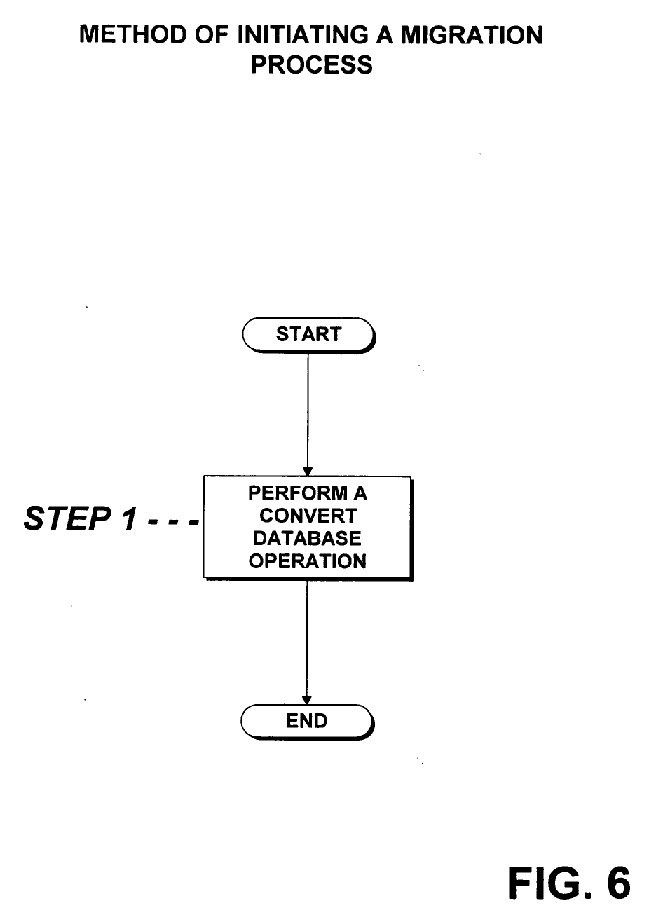

The method of initiating a migration process can best be seen in FIG. 6, which is a process flow chart of the initiating process of the present invention, and as such, will be discussed with reference thereto.

The method of initiating a migration process comprises the step of:
STEP 1: Performing a convert database operation.

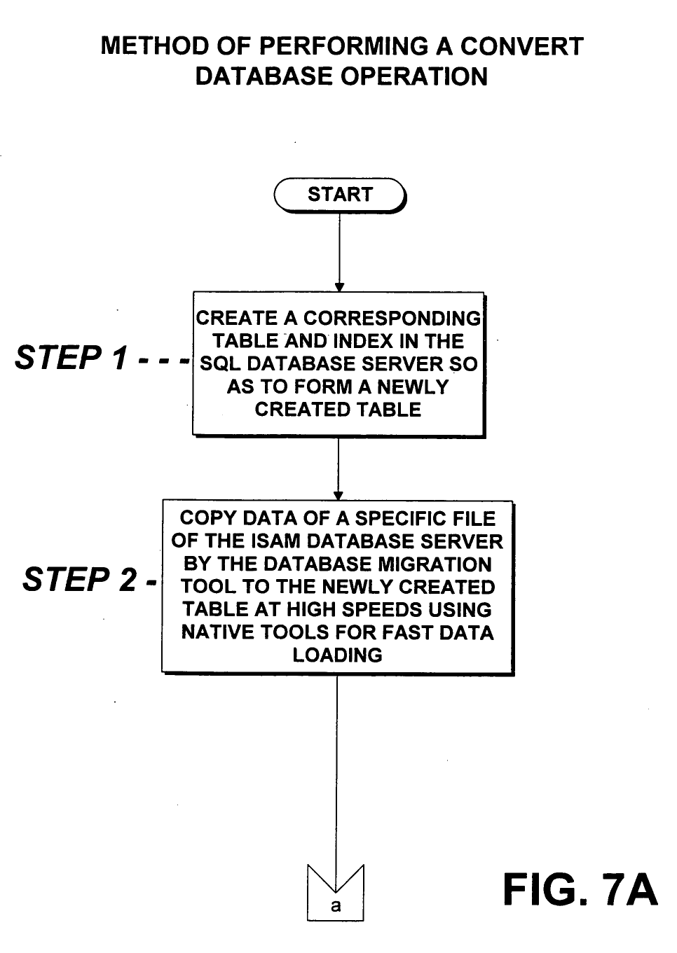

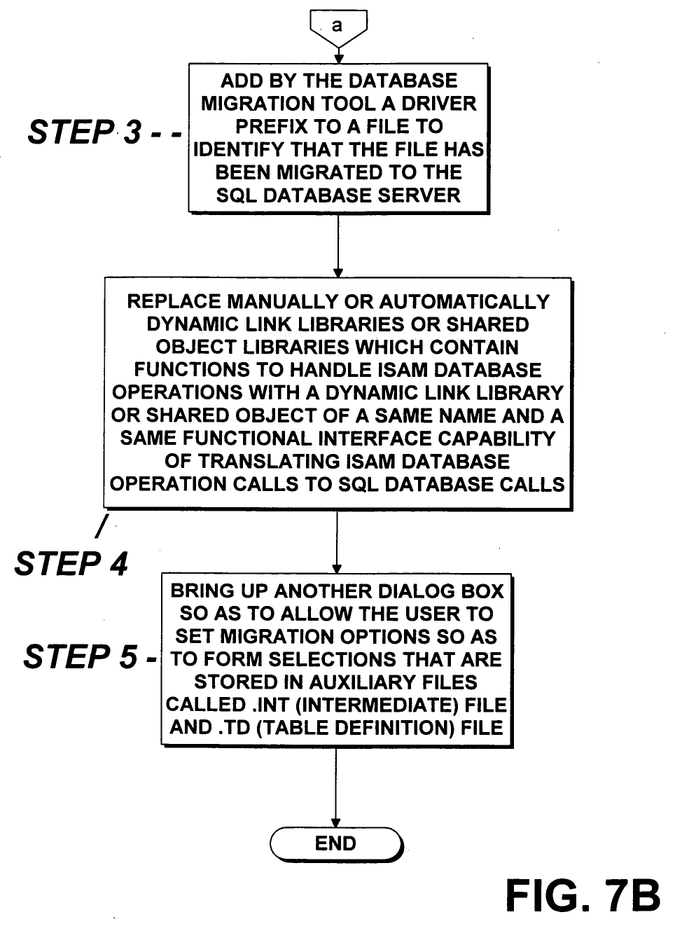

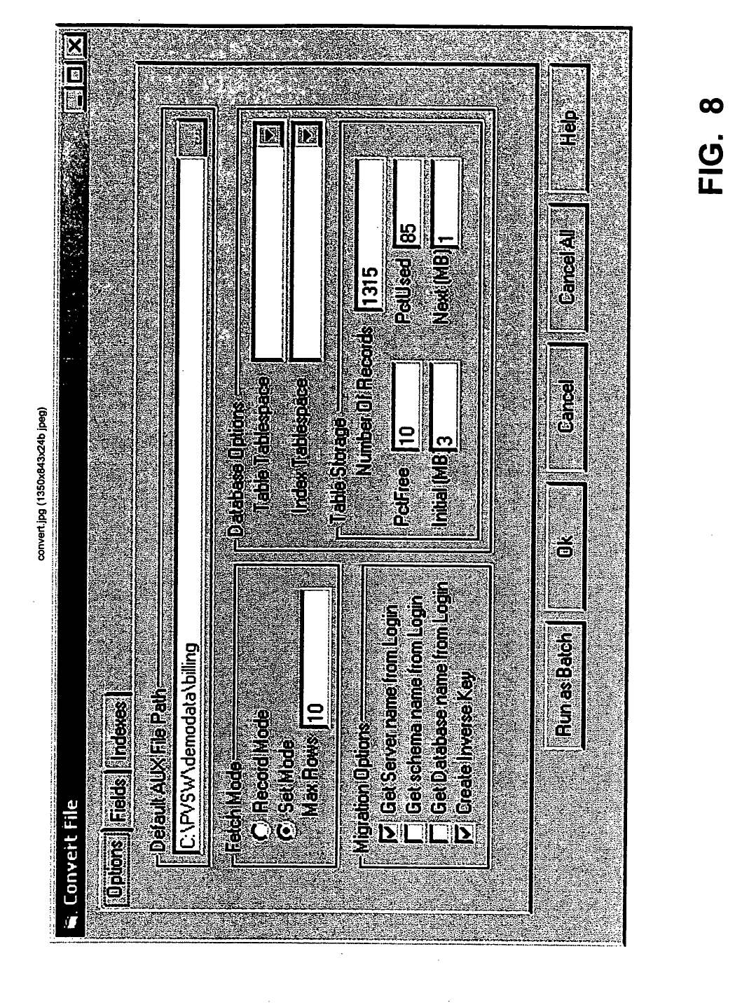

The method of performing a convert database operation can best be seen in FIGS. 7A, 7B, and 8, which are, respectively, a process flow chart of the performing process of the present invention, and an options dialog box, and as such, will be discussed with reference thereto.

The method of performing a convert database operation comprises the steps of:
STEP 1: Creating a corresponding table and index in the SQL database server so as to form a newly created table by the database migration tool generating SQL scripts.
STEP 2: Copying data of a specific file of the ISAM database server by the data migration tool to the newly created table at high speeds using native tools for fast data loading, such as native data high speed data loading mechanisms and application programming interfaces.
STEP 3: Adding by the database migration tool a driver prefix to a file to identify that the file has already been migrated to the SQL database server.
STEP 4: Replacing manually or automatically dynamic link libraries or shared object libraries which contain functions to handle ISAM database operations with a dynamic link library or shared object of a same name and a same functional interface capable of translating ISAM database operation calls to SQL database calls.
STEP 5: Bringing up another dialog box (FIG. 8) so as to allow the user to set migration options so as to form selections that are stored in auxiliary files called .INT (intermediate) file and .TD (table definition) file.

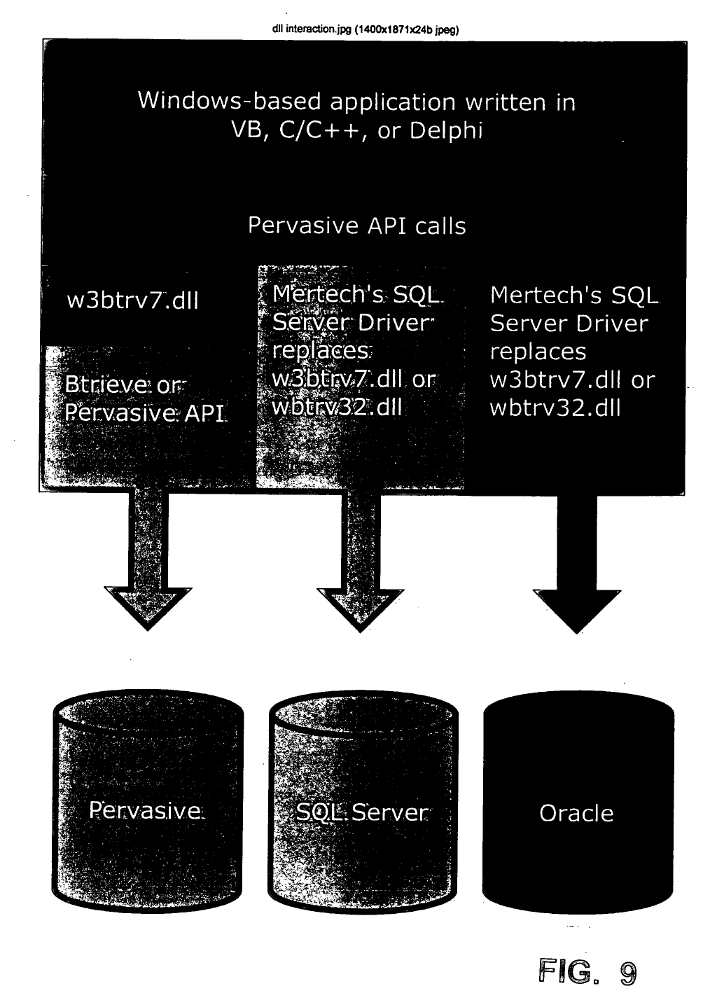

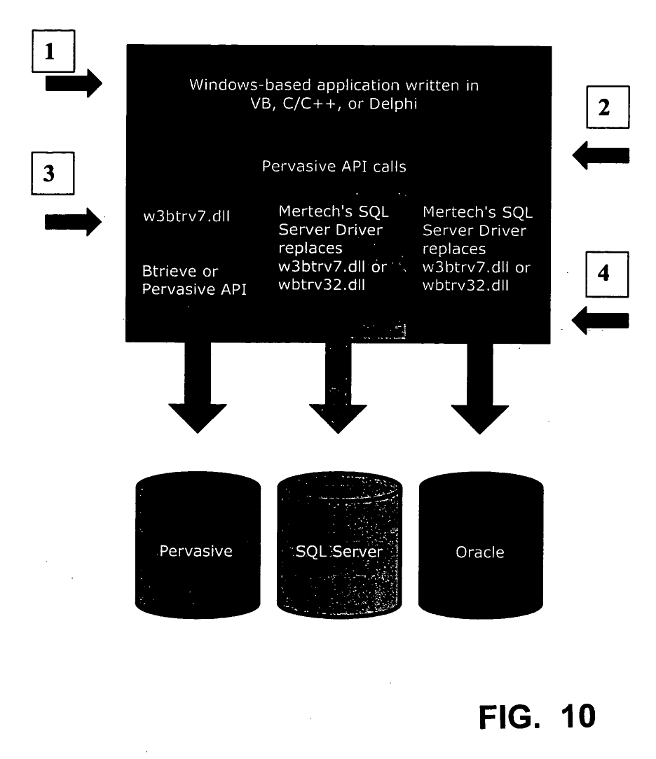

To understand how the various components interact with each other, the migrated application can be broken down into four separate layers as shown, by way of examples, in FIGS. 9 and 10, which are, respectively, a diagram of the interaction of the four layers of the migration application when the SQL database server is an MS SQL server, and a diagram of the interaction of the four layers of the migration application when the SQL database server is an Oracle server.
LAYER 1: Application code (VB, Delphi, C/C++, etc).
LAYER 2: ISAM API layer.
LAYER 3: Internal API layer of the present invention.
LAYER 4: SQL Native API layer.

### Layer 1—Application Code

There is no change required in the application if the user simply replaces the ISAM dlls with the present invention dills of the same name. The user, however, can access both the SQL database server and the ISAM database servers from the same application by using the same present invention driver, but deployed under a different name. In this case, the user will make changes to the source code to call the drivers of the present invention depending on the code used, for example:

When the source code is Visual Basic, the SQL database server is an MS SQL server, and the ISAM is BTRIEVE®:
Declare Function BTRCALL Lib “sql btr.dll”
Alias “sqlBTRCALL” (ByVal OP, ByVal Pb$,
Db As Any, DL As Integer, ByRef Kb As Any,
ByVal Kl, ByVal Kn) As Integer

When the source code is Visual Basic, the SQL database server is an Oracle server, and the ISAM is BTRIEVE®:
Declare Function BTRCALL Lib “ora btr.dll”
Alias “oraBTRCALL” (ByVal OP, ByVal Pb$,
Db As Any, DL As Integer, ByRef Kb As Any,
ByVal Kl, ByVal Kn) As Integer

When the source code is C/C++, the SQL database server is an MS SQL server, and the ISAM is BTRIEVE®, the “C’ programs using ISAM's wbtrv32.dll will have to be linked to use sql btr.dll (.lib). In a global file, the following has to be defined for correct function mapping:
#define BTRCALL sqlBTRCALL

When the source code in C/C++, the SQL database server is an Oracle server, and the ISAM is BTRIEVE®, the “C′ programs using ISAM's wbtrv32.dll will have to be linked to use ora btr.dll (.lib). In a global file, the following has to be defined for correct function mapping:
#define BTRCALL oraBTRCALL

### Layer 2—ISAM API Calls

All applications using ISAM database servers use functional interfaces residing in ISAM's dynamic link libraries. The application will make its usual calls to the ISAM database server, passing ISAM function codes.

As an example, when the ISAM is BTRIEVE®, the applications use BTRV( ) function calls residing in ISAM's dynamic link libraries wbtrv32.dll or w3btrv7.dll.

### Layer 3—Internal API of Present Invention

Because the present invention driver replaces the ISAM dlls calls to the ISAM database server from the application, the calls are trapped and translated into SQL statements and sent to the SQL database server.

As an example, when the SQL database server is an MS SQL server OLEDB calls are used and when the SQL database server is an Oracle server OCI calls are used.

### Layer 4—SQL Backend Native API

With a translated set of commands to the data source, the application can now transparently interact with the SQL database server through the native API calls in the present invention drivers. Furthermore, the SQL statements generated by the drivers are optimized for the best possible performance.

It will be understood that each of the elements described above or two or more together may also find a useful application in other types of constructions differing from the types described above.

While the invention has been illustrated and described as embodied in a system and method for migrating an application developed around an ISAM database server to an SQL database server without source level changes, however, it is not limited to the details shown since it will be understood that various omissions, modifications, substitutions, and changes in the forms and details of it illustrated and its operation can be made by those skilled in the art without departing in any way from the spirit of the present invention.

Without further analysis, the foregoing will so fully reveal the gist of the present invention that others can by applying current knowledge readily adapt it for various applications without omitting features that from the standpoint of prior art fairly constitute characteristics of the generic or specific aspects of the invention.

1. A system for migrating an application developed around an ISAM database server to an SQL database server without source level changes, said system comprising:
a) a database migration tool; and
b) a database driver;
wherein said database migration tool migrates data from the ISAM database server to the SQL database server in such a manner that transparency of data operation is maintained from a perspective of the application; and
wherein said database driver intercepts functional calls specifying any database operation made to the ISAM database server from the application and translates them into corresponding SQL functional calls and statements in such a manner that allows complete transparency between the SQL database server and the application so as to allow the application to continue to perform as it normally does and continue to receive and send data to the SQL database server in a format it expects with the ISAM database server.

2. The system as defined in claim 1, wherein said database migration tool is a standard 32-bit application that runs on a MICROSOFT® WINDOWS™ platform.

3. The system as defined in claim 1, wherein said database driver uses a native low level API to communicate with the SQL database server.

4. The system as defined in claim 1, wherein said database driver provides a direct connection to the SQL database server.

5. The system as defined in claim 1, wherein said database migration tool sets up the SQL database server.

6. The system as defined in claim 1, wherein said database migration tool copies data at high speeds using native tools for fast data loading.

7. The system as defined in claim 1, wherein said database migration tool copies data at high speeds using native high speed data loading mechanisms and application programming interfaces.

8. The system as defined in claim 1, wherein said database migration tool generates SQL scripts to create tables and indexes.

9. The system as defined in claim 1, wherein said database migration tool is a GUI application that sets up a necessary environment and files that are later used by said database driver.

10. The system as defined in claim 1, wherein said database migration tool translates database and security information from the ISAM database server to the SQL database server;
wherein the database information comprises data files or table definitions; and
wherein the database information comprises index information.

11. The system as defined in claim 1, wherein said database migration tool reads table and index definitions;
wherein said database migration tool performs data type translation by mapping data types from the ISAM database server to the SQL database server;
wherein said database migration tool reads security information on files to be translated;
wherein said database migration tool generates migration reports and function call traces;
wherein said database migration tool allows users to browse data before and after translation;
wherein said database migration tool allows switching between the ISAM and the SQL database servers by just adding or removing driver name prefixes;
wherein said database migration tool generates scripts for fast loading of data into native types by generating text files and scripts that can be used by the SQL database server for high-speed database migration;
wherein said database migration tool allows migrated tables to be removed or dropped from the SQL database server;
wherein said database migration tool allows data to be read back into a table of the ISAM database server from a corresponding migrated table of the SQL database server; and
wherein said database migration tool generates auxiliary flies with appropriate table information so as to allow said database driver to function properly in its task as functional translator.

12. The system as defined in claim 1, wherein a type of functional translation said database driver performs is dependent on the ISAM database server and the SQL database server between which said database driver acts as a middle-ware or bridge.

13. The system as defined in claim 1, wherein said database driver has an ability to find and fetch a first record of a table based on a given index or a default index;
wherein said database driver has an ability to find and fetch a last record of a table based on a given index or a default index;
wherein said database driver has an ability to find a next record in a table based on a given index;
wherein said database driver has an ability to find a previous record in a table based on a given index;
wherein said database driver has an ability to find a record with index values greater than a current active record based on a given index;
wherein said database driver has an ability to find a record which has index values greater than or equal to a current active record in a record buffer;
wherein said database driver has an ability to find a record which has index values less than or equal to a current active record in a record buffer; and
wherein said database driver has an ability to find a record from a table which has index values exactly the same as a current active record in a record buffer.

14. The system as defined in claim 1, wherein said database driver has an ability to find an existing record, apply changes to the record made by the user via the application interface so as to form an updated record, and save the updated record back in a table of the SQL database server.

15. The system as defined in claim 1, wherein said database driver has an ability to find a record and delete the record specified by the application.

16. The system as defined in claim 1, wherein said database driver has an ability to save a newly created record into a table of the SQL database server.

17. The system as defined in claim 1, wherein said database driver has an ability to start a transaction on the SQL database server and provide a same transactional functionality of the ISAM database server.

18. The system as defined in claim 1, wherein said database driver has an ability to send a transaction instruction to the SQL database server and make the transaction permanent by committing to disk.

19. The system as defined in claim 1, wherein said database driver has an ability to issue an abort transaction command in an event of an error during a begin/end transaction block so as to allow the transaction to be rolled back restoring record buffers and tables to their original states.

20. The system as defined in claim 1, wherein said database driver allows structure of an existing index to be modified by the application.

21. The system as defined in claim 1, wherein said database driver allows functionality to add a new field to an existing table that is supported by the SQL database server.

22. The system as defined in claim 1, wherein said database driver supports creation of a new index on a table.

23. The system as defined in claim 1, wherein said database driver supports deletion of a field from an existing table.

24. The system as defined in claim 1, wherein said database driver allows dropping an existing index from a table.

25. The system as defined in claim 1, wherein said database driver provides a mechanism to implement auto-increment fields that are available in many ISAM databases as well as SQL databases in such a way that the application sees no difference between the ISAM database server and the SQL database server even though the SQL database server handling is different.

26. The system as defined in claim 1, wherein said database driver provides support for case insensitive indexes available in most ISAM databases but likely absent in some SQL databases; and
wherein said database driver provides support for an index that contains ascending and descending index segments in order to avoid costly ORDER BY clauses in an SQL statement.

27. The system as defined in claim 1, wherein said database driver provides a mechanism to switch between record-at-a-time access provided by the ISAM database server and set-based access provided by the SQL database server so as to perform order entry or order update by using the record-at-a-time access while for reports or batch processes by using set-based access.

28. The system as defined in claim 1, wherein said database driver provides support for all authentication methods for the SQL database server since the ISAM database server may or may not provide a secure authentication based security service for accessing tables while this is a standard requirement in the SQL database server;
wherein said database driver automatically pops a login dialog box if a file is opened without being logged onto the SQL database server;
wherein said database driver provides support for a login command that can be added to an application either compiled in or externally to support security services;
wherein the login command creates a connection handle which uniquely identifies a user connection;
wherein the connection handle is kept in memory in a data structure during execution of the application; and
wherein a logout command destroys the memory in the data structure and releases the connection handle.

29. The system as defined in claim 1, wherein a file open command opens an auxiliary file that is needed to create a memory structure about both ISAM and SQL tables since the ISAM database server has to open a file before it can access a file whereas in the SQL database server there is no concept of file open;
wherein the auxiliary file contains information about table structure that is not supported by the SQL database server but is needed by the application;
wherein the auxiliary file is stored both as a binary and as a text file; and
wherein said database driver supports a close function by destroying all memory structure created by the file open command and closes a table handle for a table since closing a file of the ISAM database server means the handle for the file is released and the file is no longer used by the application whereas the SQL database server doesn't require a table to be closed.

30. The system as defined in claim 1, wherein said database migration tool performs a convert database operation by creating a corresponding table in the SQL database server so as to form a newly created table and copying data of the ISAM database server to the newly created table.

31. The system as defined in claim 30, wherein said database migration tool during said convert database operation brings up another dialog box to allow the user to set migration options so as to form selections.

32. The system as defined in claim 31, wherein said selections are stored in auxiliary files called .INT (intermediate) file and .TD (table definition) file.

33. The system as defined in claim 1, wherein said database driver supports setting and fetching table and database attributes when requested by the application.

34. The system as defined in claim 33, wherein a table attribute is finding out a total number of records in a table;
wherein said database driver when requested by the application fetches a count of total number of records in the SQL database server and provides it to the application;
wherein a table attribute is a maximum number of records allowed; and
wherein a table attribute is file mode/read only or not.

35. The system as defined in claim 33, wherein a table attribute is changing field names or field types.

36. The system as defined in claim 1, wherein said database driver provides a mechanism to support additional commands specific to said database driver that result in increased performance.

37. The system as defined in claim 36, wherein the additional commands include commands that restrict number of columns to be fetched from a table by allowing the application to switch between complete record and selected fields fetch mechanism by virtue of ISAM databases typically fetching a complete record at a time while most applications written for SQL databases fetch only needed columns or fields from tables.

38. The system as defined in claim 1, wherein said database migration tool identifies any repository containing information regarding an ISAM database structure to migrate;
wherein said database migration tool allows a user to choose which data files of the ISAM database server will be migrated; and
wherein said database migration tool initiates migration.

39. The system as defined in claim 38, wherein the repository containing information regarding an ISAM database structure includes data dictionaries, file definitions, or file lists.

40. The system as defined in claim 38, wherein the ISAM database structure includes tables, indexes, sequences definitions, and any other information defining an ISAM database structure.

41. The system as defined in claim 1, wherein said database migration tool allows a user to locate and select a repository containing information regarding an ISAM database structure and display file entries in a file list dialog box by virtue of said database migration tool working with the repository containing information regarding an ISAM database structure

42. The system as defined in claim 41, wherein the repository containing information regarding an ISAM database structure includes data dictionaries, file definitions, or file lists.

43. The system as defined in claim 41, wherein the ISAM database structure includes tables, indexes, sequences definitions, and any other information defining an ISAM database structure.

44. The system as defined in claim 1, wherein said database migration tool adds a driver prefix to a file to identify that the file has already been migrated to the SQL database server.

45. The system as defined in claim 44, wherein said prefix is a name of the driver dll.

46. A method for migrating an application developed around an ISAM database server to an SQL database server without source level changes, said method comprising the steps of:
a) setting up by a database migration tool the SQL database server and migrating by the database driver data from the ISAM database server to the SQL database server in such a manner that transparency of data operation is maintained from a perspective of the application; and
b) intercepting by a database driver functional calls specifying any database operation made to the ISAM database server from the application and translating them by the database driver into corresponding SQL functional calls and statements in such a manner that allows complete transparency between the SQL database server and the application so as to allow the application to continue to perform as it normally does and continue to receive and send data to the SQL database server in a format it expects with the ISAM database server.

47. The method as defined in claim 46, wherein said setting up step includes the steps of:
a) identifying any repository containing information regarding an ISAM database structure to migrate;
b) choosing which data files will be migrated; and
c) initiating a migration process.

48. The method as defined in claim 47, wherein the ISAM database structure includes tables, indexes, sequences definitions, and any other information defining an ISAM database structure.

49. The method as defined in claim 47, wherein the repository containing information regarding an ISAM database structure includes data dictionaries, file definitions, or file lists.

50. The method as defined in claim 47, wherein said identifying and choosing steps include the steps of:
a) allowing a user to locate and select the repository containing information regarding an ISAM database structure entry in a file list dialog box by virtue of the database migration tool working with the repository containing information regarding an ISAM database structure; and
b) selecting by the user any number of files to migrate by highlighting file names.

51. The method as defined in claim 50, wherein said selecting step includes selecting by a user any number of files to migrate by highlighting file names in the file list dialog box.

52. The method as defined in claim 47, wherein said initiating step includes the step of performing a convert database operation; and
wherein said performing step includes the steps of:
a) creating a corresponding table in the SQL database server so as to form a newly created table; and
b) copying data of a specific file of the ISAM database server to the newly created table.

53. The method as defined in claim 52, wherein said creating step includes the step of generating by the database migration tool SQL scripts to create tables and indexes.

54. The method as defined in claim 52, wherein said performing step further includes the step of replacing manually or automatically dynamic link libraries or shared object libraries which contain functions to handle ISAM database operations with a dynamic link library or shared object of a same name and a same functional interface capable of translating ISAM database operation calls to SQL database calls.

55. The method as defined in claim 52, wherein said performing step further includes the step of bringing up another dialog box; and
wherein said bringing up step includes the step of allowing the user to set migration options so as to form selections.

56. The method as defined in claim 52, wherein said copying step includes the step of copying data by the database migration tool at high speeds using native tools for fast data loading.

57. The method as defined in claim 56, wherein said copying step includes copying data by the database migration tool at high speeds using native high speed data loading mechanisms and application programming interfaces.

58. The method as defined in claim 55, wherein said selections are stored in auxiliary files called .INT (intermediate) file and .TD (table definition) file.

59. The method as defined in claim 55, wherein said performing step further includes the step of adding by the database migration tool a driver prefix to a file to identify that the file has already been migrated to the SQL database server.
